(19) United States
(12) Patent Application Publication
(10) Pub. No.: US 2007/0242015 A1
(43) Pub. Date: Oct. 18, 2007

(54) H-bridge driver for electroluminescent lamp that reduces audible noise

(75) Inventors: Douglas P. Anderson, Nevada, IA (US); David W. Ritter, San Jose, CA (US)

Correspondence Address: PATENT LAW GROUP LLP, 2635 NORTH FIRST STREET, SUITE 223, SAN JOSE, CA, 95134, US

(73) Assignee: Micrel, Inc.

(21) Appl. No.: 11/404,419

(22) Filed: Apr. 13, 2006

(51) Int. Cl. G09G 3/36

(52) U.S. Cl. 345/92

(57) ABSTRACT

A low noise H-bridge driver for EL lamps is described herein. The H-bridge controls switching transistors to create an AC voltage across the EL lamp. To reduce audible noise of the EL lamp when driven by an H-bridge, the current through the switching transistors is limited while the voltage across the EL lamp is rising and falling. This reduces the ramp rate of the voltage across the EL lamp and, as a result, reduces vibrations to an inaudible level. The rise time and fall time may each constitute 5%-50% of a half waveform. The rise and fall portions are substantially linear and symmetrical for the half waveform. Current may be limited by using two or more MOSFETs in the H-bridge that have relatively small gate widths. Current mirrors connected to fixed low current sources may also be connected to two or more switching transistors in the H-bridge, or current mirrors may be connected to the common nodes of the H-bridge, so that the transistors conduct a current proportional to the fixed low current when turned on.

### FIELD OF THE INVENTION

This invention relates to a driver for electroluminescent (EL) lamps.

### BACKGROUND

Electroluminescent (EL) lamps are commonly used as liquid crystal display (LCD) backlights for small displays such as in cell phones, watches, pagers, gauges, and portable music players. EL lamps are basically formed of a top transparent electrode plate, a bottom electrode plate, and a phosphor/dielectric sandwiched between the two plates. The phosphor/dielectric may be a sintered phosphor grain layer overlying a dielectric layer. The phosphor glows when a high AC voltage is applied across the electrodes. The type of phosphor used, the phosphor density, the voltage, the frequency, and other factors determine the color and brightness.

The EL lamp is basically a capacitor whose voltage is determined by the charge on its plates, the size of the plates, the thickness of the dielectric, the type of dielectric used, and other factors. The dv/dt across the plates, which is proportional to the current, controls the brightness. The magnitude of current used to charge the plates determines the speed at which the EL lamp charges to its final operating voltage. Once the EL lamp is charged to its final voltage, the voltage stays relatively constant for a short time, depending on the AC frequency, and then the polarity of voltage across the EL lamp is reversed. It is the normal practice to create minimum rise and fall times of the AC voltage since this maximizes the overall brightness of the EL lamp.

The frequency of the AC voltage is in the audible range and is typically 100-2000 Hz. The peak to peak voltage across the EL lamp is typically 100-400 volts. The high voltage (HV) is typically generated from a very low voltage battery (e.g., 1.5 volt) using a boost circuit comprising an inductor, connected to the power supply voltage, that charges by turning on a switching transistor connected to ground and then discharges through a diode when the switching transistor is turned off. A smoothing capacitor is kept at a relatively constant high voltage by being intermittently charged by the inductor at a certain average current and intermittently discharged by the EL lamp at the same average current. The switching frequency of the HV supply is usually at least double the frequency of the voltage across the EL lamp. The HV supply may use any boost technique.

FIG. 1A illustrates a simple EL lamp driver consisting of an H-bridge 10 and an H-bridge sequencer 12. The H-bridge 10 consists of alternately conducting PMOS transistors 14 and 15 and alternately conducting NMOS transistors 16 and 17. Bipolar transistors and diodes may be used as switches instead of MOSFETs.

FIG. 1B illustrates the voltage at the VA and VB terminals of the EL lamp 20 due to the switching of the four transistors. The corners of the waveform would be rounded in an actual waveform due to the capacitive effects of the EL lamp 20.

The H-bridge sequencer 12 first turns on transistors 14 and 17 to apply the full HV supply voltage (node 22) to the VA terminal of the EL lamp 20 at a high current to turn the EL lamp 20 on as quickly as practical to achieve maximum brightness. The high current is achieved by large gate widths of the transistors. After the short rise time, the EL lamp 20 is fully charged to the HV supply voltage. An oscillator then controls the sequencer 12 to turn off transistors 14 and 17 and turn on transistors 15 and 16 to apply the full HV supply voltage to the VB terminal of the EL lamp 20 at a high current.

A short zero voltage interval is represented by the waveform, indicating a non-overlapping conduction interval. The interval may be obtained by turning off both PMOS transistors and turning on both NMOS transistors. This discharges the EL lamp to 0 volts.

Due to the large gate widths, the transistors can conduct relatively large currents while ramping up the voltage to quickly raise the EL lamp 20 to its maximum voltage to achieve maximum brightness. Due to the very fast charging and discharging rates of the EL lamp 20, audible vibrations of the EL lamp 20 are created by the nature of the EL lamp's construction, and the vibrations may be heard as a buzzing by someone close to the backlight.

Techniques to reduce audible noise have been used, such as those described in U.S. Pat. Nos. 6,555,967 and 5,789,870, incorporated herein by reference. In these techniques, the ramping up of the voltage is controlled so that the waveform has an exponential shape Before the voltage ramps up to a maximum, the transistors switch to reverse the voltage polarity, and the waveform then quickly falls in an exponential manner. The half waveform is not symmetrical. As a result, the EL lamp is never fully charged, and its duty cycle is reduced by at least one-third. This limits the maximum brightness of the EL lamp. Further, the rise and fall characteristics are not mirror images, since the fall is abrupt, so the prior art techniques take care of only half of the audible noise problem.

### SUMMARY

A low noise H-bridge driver for EL lamps is described herein. To reduce audible noise of the EL lamp when driven by an H-bridge, the current through the switching transistors is limited while the voltage across the EL lamp is ramping up or down. This reduces the ramp rate of the voltage across the EL lamp and, as a result, reduces vibrations and audible noise to a lower and possibly inaudible level.

The preferred driver provides a rise time of between 5%-50% of a half period waveform and a substantially mirror image fall time of between 5%-50%. During the middle portion of each switching state, the EL lamp is at approximately a maximum voltage. The resulting half period waveform is substantially symmetrical, and the rising and falling portions of the waveform are substantially linear. If the rise times and fall times are small enough, such as 5%-25% of the waveform's period, the EL lamp will achieve substantially its maximum voltage during the cycle, the audible noise will be virtually eliminated, and the rise and fall times will remain short enough for high EL lamp brightness.

Techniques to limit the current through the transistors include: 1) providing switching transistors with a relatively small gate width and reduced gate source voltage (assuming MOSFETS); 2) providing current mirrors to cause the current through the transistors to be the same as or proportional to a fixed current source; or 3) using a feedback signal to keep the current below a threshold. Other suitable techniques for limiting current may also be used.

Increasing the rise and fall times of the voltage inherently reduces the overall brightness of the EL lamp for a particular frequency. However, for a −6 dB reduction in peak acoustic output (one-fourth the acoustic output), as a result of increasing the rise and fall times, the reduction in overall brightness is surprisingly only about 3%, which would be unnoticeable to the viewer. Much lower peak acoustic output reduction is obtained by further increasing the rise and fall times.

### BRIEF DESCRIPTION OF THE DRAWINGS

FIG. 1A illustrates a simple prior art H-bridge driver for an EL lamp.

FIG. 1B is a simplified waveform of the driving voltage across the EL lamp of FIG. 1A for a prior art H-bridge driver, where the transistors are not designed to be current limited when ramping up the voltage.

FIG. 2A is a driver system for an EL lamp in accordance with one embodiment of the invention where the transistors are current limited by operating in saturation when ramping up the voltage across the EL lamp.

FIG. 2B is a simplified waveform of the voltage across the EL lamp using the driver of FIG. 2A, resulting in reduced noise.

FIG. 3A is a driver system for an EL lamp in accordance with another embodiment of the invention where current mirrors for the low side switching transistors are used to limit the current through the switching transistors to a constant current.

FIG. 3B is a simplified waveform of the voltage across the EL lamp using the driver of FIG. 3A, resulting in reduced noise.

FIG. 4 illustrates a current mirror that may be used for the high side PMOS transistors to limit the current.

FIG. 5 shows the tested relationship between rise time, light output, and peak acoustic output, indicating a negligible effect on brightness with a very noticeable reduction in noise.

Elements labeled with the same numeral are identical or equivalent.

### DETAILED DESCRIPTION

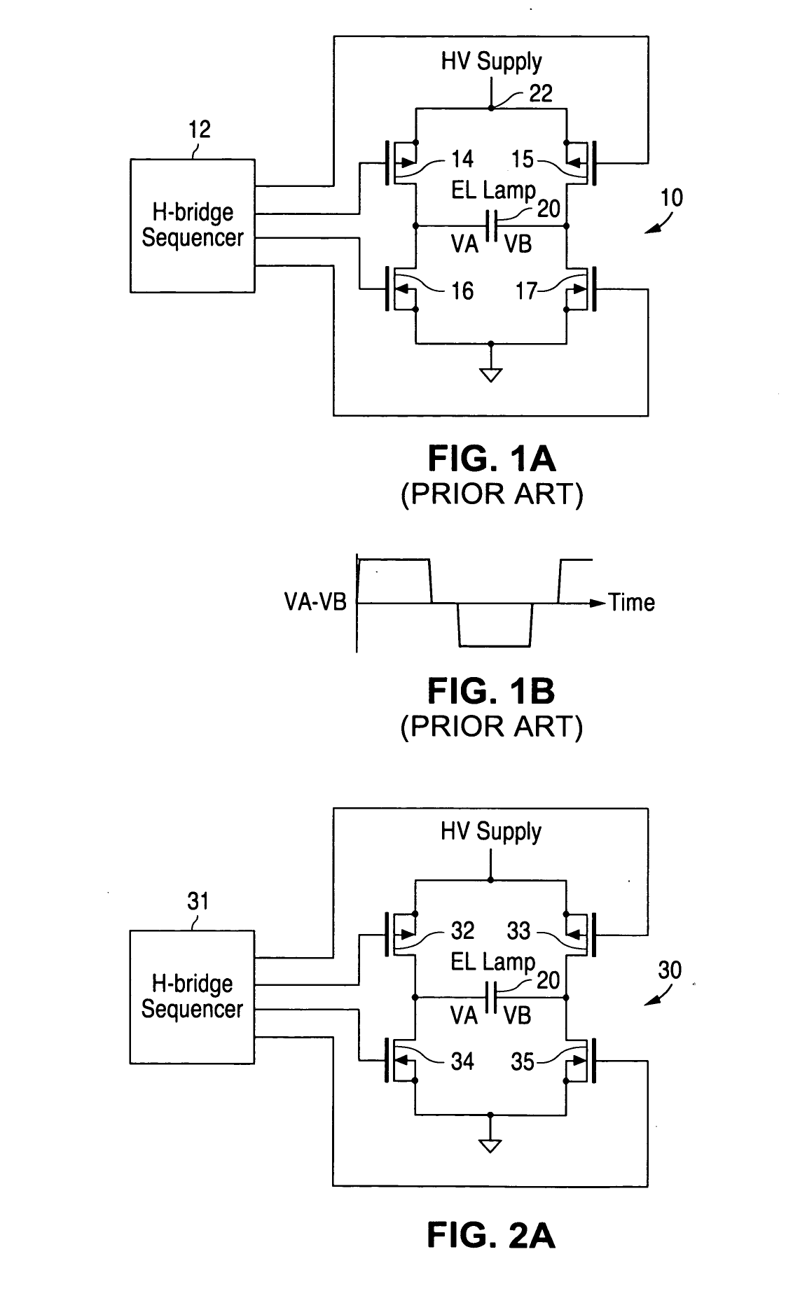

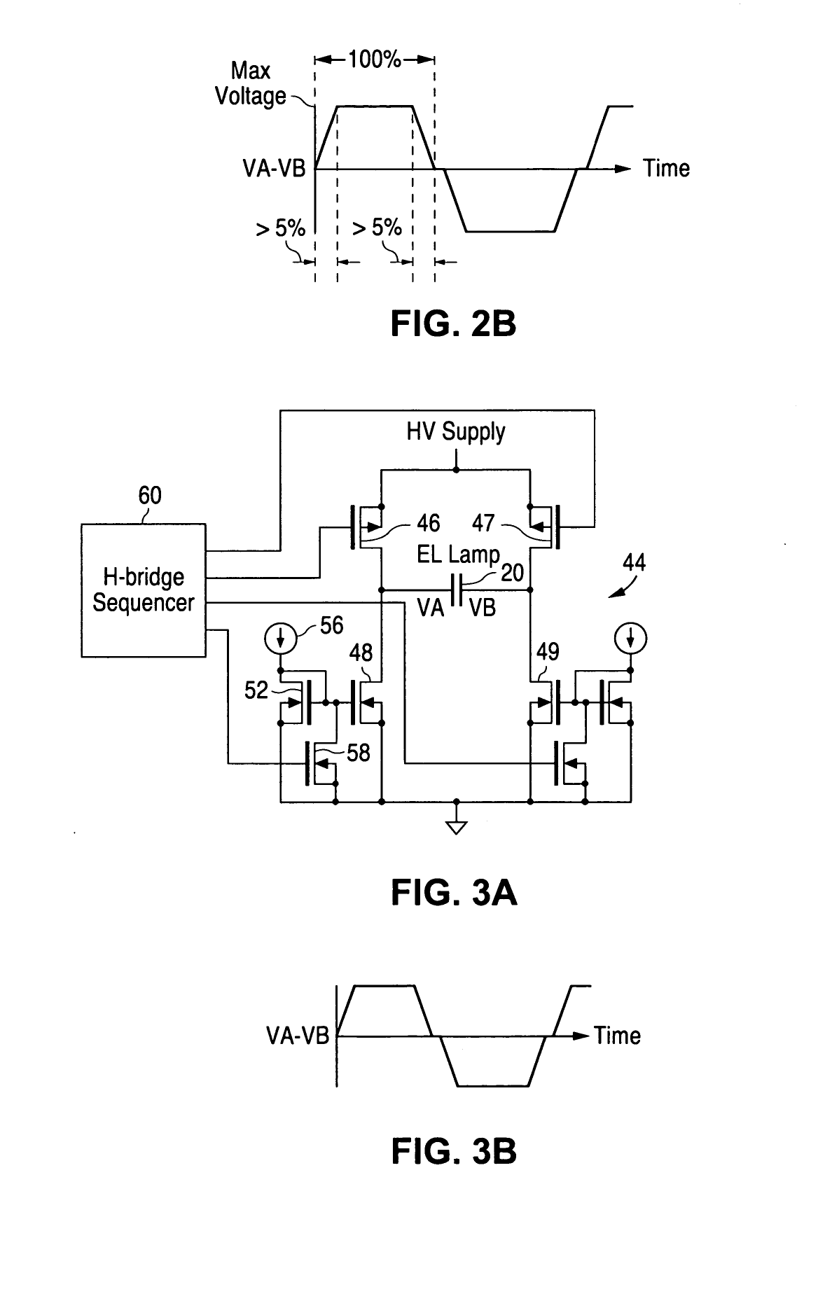

FIG. 2A illustrates an H-bridge driver 30 for an EL lamp 20 that produces less audible noise than the driver of FIG. 1A. The H-bridge sequencer 31 may be similar to that in FIG. 1A and is simply logic driven by an oscillator to alternatively control the transistors 32-35 as described with respect to FIG. 1A. The logic may include delay to avoid cross-conduction of the transistors.

In the driver 30 of FIG. 2A, at least one transistor in either of the two current paths is current limited to increase the rise and fall times of the voltage across the EL lamp 20.

By limiting the current through the transistors, the waveform of FIG. 2B is produced. The waveform has a roughly trapezoidal shape rather than the rectangular shape of FIG. 1B. The increase in rise and fall times smoothes the vibration of the EL lamp 20 caused by the AC driver signal so as to greatly reduce the audible noise with negligible reduction in overall brightness, described later with respect to FIG. 5.

To obtain a short zero voltage interval, either the PMOS transistors are turned on and the NMOS transistors are turned off, or the PMOS transistors are turned off and the NMOS transistors are turned on, by the sequencer 31 for the interval. The current limiting of the transistors provides a linear ramp to the zero voltage interval state.

The preferred driver provides a rise time of between 5%-50% of a half period waveform and a substantially mirror image fall time of between 5%-50%. During the middle portion of each switching state, the EL lamp is at approximately a maximum voltage. The resulting half period waveform is substantially symmetrical, and the rising and falling portions of the waveform are substantially linear. If the rise times and fall times are small enough, such as 5%-25% of the waveform's period, the EL lamp will achieve substantially its maximum voltage during the cycle, the audible noise will be reduced, and the EL lamp brightness will remain high.

The half period waveform may be roughly trapezoidal with rounded edges. The optimal percentage of the rise and fall times depends on the amount of audible noise to eliminate. In one example where the rise and fall times are each about 50% of the total waveform, the AC waveform will be substantially triangular. However, the rise and fall times will be long, resulting in a relatively low brightness EL lamp.

One way to limit the current through the transistors during the ramping stage of the waveform of FIG. 2B is to provide transistors (either all or just one transistor in each current path) with a reduced gate width compared to the gate widths of the transistors of FIG. 1A so that the transistors 32-37 conduct a current that is limited during the rise and fall times of the AC voltage waveform. In addition, the gate drive provided by the sequencer 31 (or by another circuit) may be reduced compared to that in FIG. 1A to drive the transistors 32-37 at a lower saturation current level.

The reduced gate width transistors will almost immediately go into saturation after switching, where the drain-source voltage has a negligible effect on current. In saturation, with a fixed Vgs, the current is limited. When the transistor is saturated during the rise and fall times, and the gate width is sufficiently small, the rise and fall times will be extended beyond the FIG. 1B rise and fall times, as shown in FIG. 2B.

To further limit the current through the current limited transistors, the drive voltage provided by the sequencer 31 (or other circuit) may be slightly above the threshold voltage. The current through a transistor in the saturated region is approximately proportional to (Vgs−Vth)².

In one embodiment, the maximum current through the transistors of FIG. 2A is about 50%-75% of the operating current of the prior art transistors during the rise and fall times of the AC voltage across the EL lamp. The current supplied by transistors for a small EL lamp is on the order of 3-40 mA depending on the size and type of EL lamp and the frequency.

In one embodiment, the gate width of the current limited transistors 32-35 is reduced by about 25%-75 % compared to the prior art, assuming all other aspects of the system are the same.

FIG. 3A illustrates an H-bridge driver 44 using another technique to limit the current through the driver transistors 46-49 to increase the rise and fall times. A current mirror for the low side transistor 48 is created by a current mirror NMOS transistor 52 having its gate and source tied to the gate and source of the low side transistor 48. A fixed “low” current source 56 is connected to the drain of the current mirror transistor 52, and the drain of the transistor 52 is connected to its gate. Tying the drain to the gate causes transistor 52 to set a gate voltage to that necessary to conduct the fixed current. A transistor 58 is either switched on by the H-bridge sequencer 60 to short the gates to ground to turn both transistors 48 and 52 off, or switched off to allow transistors 48 and 52 to conduct the fixed current. The fixed current is set to create the desired rise and fall times to reduce audible noise. An identical current mirror is provided for transistor 49 so that the waveform is substantially symmetric The voltage waveform across the EL lamp may resemble that of FIG. 3B, which is identical to the waveform of FIG. 2B.

The relative sizes of the transistors 52 and 48 may be set to make the current through the H-bridge transistor any proportion of the fixed current generated by the current source 56.

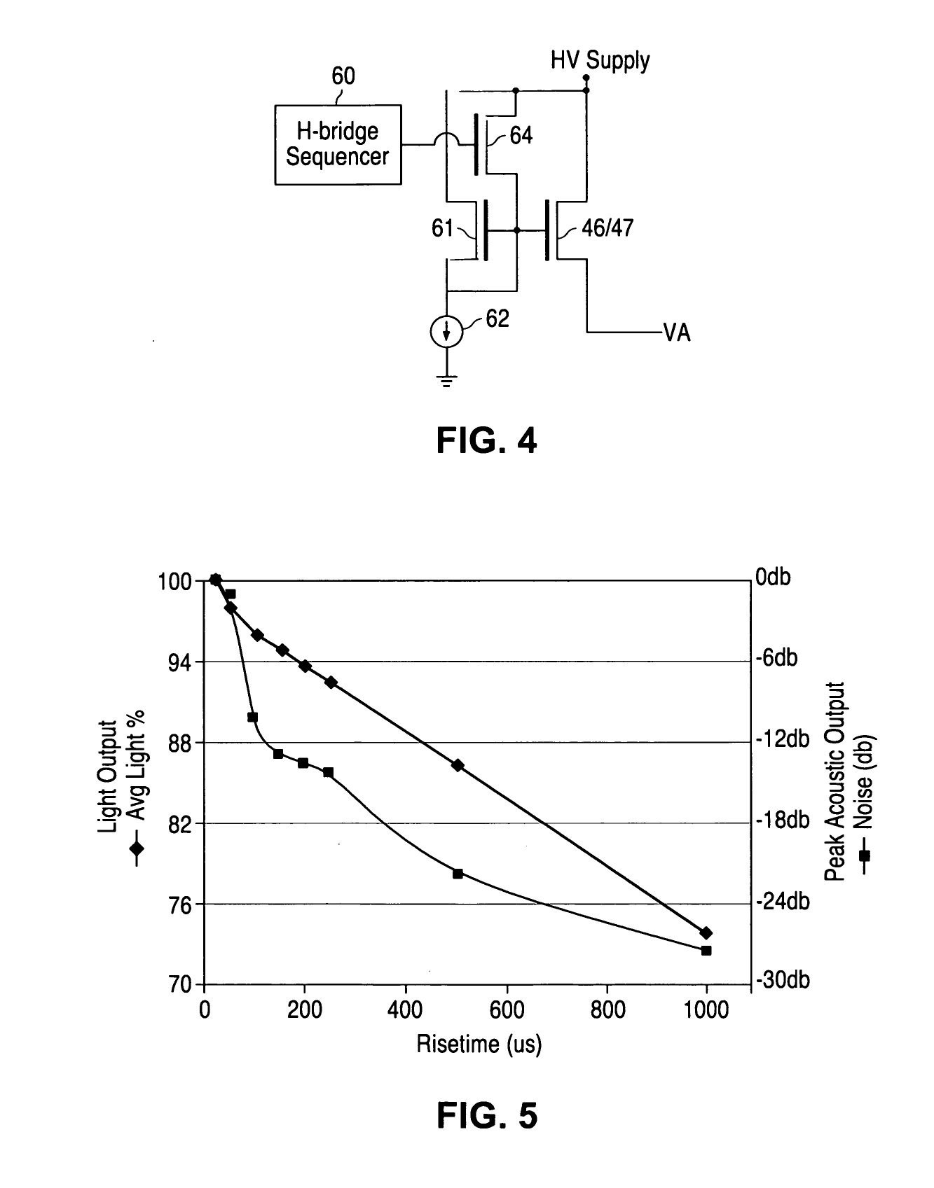

If it is desired to current limit the high side PMOS transistors 46 and 47, the current mirror of FIG. 4 may be used. A PMOS current mirror transistor 61 has its source and gate connected to the high side transistor 46 or 47, and a fixed “low” current source 62 is connected to ground. The drain of transistor 61 is connected to its gate. A transistor 64 is controlled by the sequencer 60 to turn transistors 61 and 46 on and off.

Alternatively, one PMOS transistor and one NMOS transistor in different current paths may be current limited.

Alternatively, a single current mirror at either the upper common node (connected to the HV supply) or the lower common node (connected to ground) may be used. Either one of the current mirrors in FIG. 3A may be used at the lower common node, or the current mirror in FIG. 4 may be used at the upper common node.

Other techniques for limiting current may also be used, such as using feedback to compare the current through an H-bridge transistor to a fixed reference and controlling the transistor to conduct a current proportional to the reference.

Although MOSFETs have been shown in the examples, current limited bipolar transistors may also be used.

FIG. 5 shows the tested relationship between rise time, light output, and peak acoustic output for a 240 volt peak to peak trapezoidal drive, indicating a surprisingly negligible effect on brightness with a very noticeable reduction in noise. With a reduction of peak audible noise of about −6 dB, the brightness is only reduced by about a negligible 3%. With a reduction of −12 dB, the brightness is only reduced by about a negligible 5%. With a frequency of 400 Hz (a 1.25 ms half period), a 10% rise time of 125 microseconds results in a −10 dB reduction in noise with only a 6% reduction in overall brightness.

As the EL lamp ages, its equivalent capacitance decreases and its brightness decreases. With the present invention, as the capacitance decreases, the rise and fall times of the voltage across the EL lamp will also decrease. This decreased charge time will offset the inherent reduction in brightness of the lamp.

Having described the invention in detail, those skilled in the art will appreciate that, given the present disclosure, modifications may be made to the invention without departing from the spirit and inventive concepts described herein. Therefore, it is not intended that the scope of the invention be limited to the specific embodiments illustrated and described.

What is claimed is:

1. A driver system for an electroluminescent (EL) lamp comprising:
an H-bridge comprising alternating switching transistors, the switching transistors comprising a first high side transistor coupled between a voltage supply and a first terminal of the EL lamp, a second high side transistor coupled between the voltage supply and a second terminal of the EL lamp, a first low side transistor coupled between the first terminal of the EL lamp and a reference voltage, and a second low side transistor coupled between the second terminal of the EL lamp and the reference voltage; and
an H-bridge sequencer generating control signals controlling conduction of the first high side transistor, the second high side transistor, the first low side transistor, and the second low side transistor for alternately switching the transistors so that either the first high side transistor and the first low side transistor are on simultaneously, or the second high side transistor and the second low side transistor are on simultaneously, the H-bridge sequencer switching the transistors to generate an AC voltage across the EL lamp at a certain frequency within an audible frequency range,
the AC voltage across the EL lamp having a waveform with rising and falling edges having rise times and fall times, respectively,
at least two of the transistors in the group of transistors consisting of the first high side transistor, the first low side transistor, the second high side transistor, and the second low side transistor conducting a limited current such that the rise time and fall time of the AC voltage across the EL lamp each constitute between 5% and 50% of the waveform, wherein the rising portion of the waveform and the falling portion of the waveform are substantially linear, and wherein the rising portion and falling portion are substantially symmetrical to one another, thus reducing audible vibrations caused by the AC voltage across the EL lamp.

2. The system of claim 1 wherein the first high side transistor is a first PMOS transistor, the second high side transistor is a second PMOS transistor, the first low side transistor is a first NMOS transistor, and the second low side transistor is a second NMOS transistor.

3. The system of claim 2 wherein the at least two of the transistors in the group of transistors have a gate width that limits the current to the EL lamp to set the rise time and fall time.

4. The system of claim 2 wherein the at least two of the transistors comprise the first PMOS transistor and the second PMOS transistor.

5. The system of claim 2 wherein the at least two of the transistors comprise the first NMOS transistor and the second NMOS transistor.

6. The system of claim 1 wherein the at least two of the transistors have control terminals connected to current mirrors, each current mirror being coupled to a fixed current source, the current mirrors causing the at least two transistors to conduct a current generated by the fixed current source.

7. The system of claim 6 wherein the first high side transistor is a first PMOS transistor, the second high side transistor is a second PMOS transistor, the first low side transistor is a first NMOS transistor, and the second low side transistor is a second NMOS transistor,
wherein one of the current mirrors comprises:
a first fixed current source generating a fixed current, a first current mirror PMOS transistor having a drain connected to the first fixed current source, the drain being also coupled to a gate of the first PMOS transistor and a gate of the first current mirror PMOS transistor, a source of the first current mirror PMOS transistor being coupled to the voltage supply, whereby the first PMOS transistor, when turned on by the H-bridge sequencer, conducts a current approximately proportional to the fixed current.

8. The system of claim 6 wherein the first high side transistor is a first PMOS transistor, the second high side transistor is a second PMOS transistor, the first low side transistor is a first NMOS transistor, and the second low side transistor is a second NMOS transistor,
wherein one of the current mirrors comprises:
a first fixed current source generating a fixed current, a first current mirror NMOS transistor having a drain connected to the first fixed current source, the drain being also coupled to a gate of the first NMOS transistor and a gate of the first current mirror NMOS transistor, a source of the first current mirror NMOS transistor being coupled to the reference voltage, whereby the first NMOS transistor, when turned on by the H-bridge sequencer, conducts a current approximately proportional to the fixed current.

9. The system of claim 1 further comprising a current mirror connected between the voltage supply and the H-bridge to limit the current through the transistors, wherein the at least two of the transistors in the group of transistors conduct a limited current due to the current mirror conducting a limited current.

10. The system of claim 1 further comprising a current mirror connected between the reference voltage and the H-bridge to limit the current through the transistors, wherein the at least two of the transistors in the group of transistors conduct a limited current due to the current mirror conducting a limited current.

11. The system of claim 1 wherein the rise time and fall time of the AC voltage across the EL lamp each constitute between 5% and 25% of the waveform,

12. A method performed by a driver system for an electroluminescent (EL) lamp comprising:
alternating conduction of switching transistors in an H-bridge, the switching transistors comprising a first high side transistor coupled between a voltage supply and a first terminal of the EL lamp, a second high side transistor coupled between the voltage supply and a second terminal of the EL lamp, a first low side transistor coupled between the first terminal of the EL lamp and a reference voltage, and a second low side transistor coupled between the second terminal of the EL lamp and the reference voltage; and
generating control signals controlling conduction of the first high side transistor, the second high side transistor, the first low side transistor, and the second low side transistor for alternately switching the transistors so that either the first high side transistor and the first low side transistor are on simultaneously, or the second high side transistor and the second low side transistor are on simultaneously, generating the control signals switching the transistors to generate an AC voltage across the EL lamp at a certain frequency within an audible frequency range,
the AC voltage across the EL lamp having a waveform with rising and falling edges having rise times and fall times, respectively,
conducting a limited current through at least two of the transistors in the group of transistors consisting of the first high side transistor, the first low side transistor, the second high side transistor, and the second low side transistor, such that the rise time and fall time of the AC voltage across the EL lamp each constitute between 5% and 50% of the waveform, wherein the rising portion of the waveform and the falling portion of the waveform are substantially linear, and wherein the rising portion and falling portion are substantially symmetrical to one another, thus reducing audible vibrations caused by the AC voltage across the EL lamp.

13. The method of claim 12 wherein the first high side transistor is a first PMOS transistor, the second high side transistor is a second PMOS transistor, the first low side transistor is a first NMOS transistor, and the second low side transistor is a second NMOS transistor.

14. The method of claim 13 wherein the at least two of the transistors in the group of transistors have a gate width that limits the current to the EL lamp to set the rise time and fall time.

15. The method of claim 13 wherein the at least two of the transistors comprise the first PMOS transistor and the second PMOS transistor.

16. The method of claim 13 wherein the at least two of the transistors comprise the first NMOS transistor and the second NMOS transistor.

17. The method of claim 12 wherein the at least two of the transistors have control terminals connected to current mirrors, each current mirror coupled to a fixed current source, the current mirrors causing the at least two transistors to conduct a current generated by the fixed current source,
wherein generating control signals comprises conducting the fixed current through the current mirrors and controlling the at least two of the transistors, using the current mirrors, to conduct a current approximately proportional to the fixed current generated by the fixed current source.

18. The method of claim 17 wherein generating control signals comprises generating on and off control signals to a control transistor coupled to a control terminal of the at least two of the transistors.

19. The method of claim 12 wherein conducting a limited current through the at least two of the transistors in the group of transistors comprises a current mirror connected between the voltage supply and the H-bridge limiting the current through the transistors in the H-bridge.

20. The method of claim 12 wherein conducting a limited current through the at least two of the transistors in the group of transistors comprises a current mirror connected between the reference voltage and the H-bridge limiting the current through the transistors in the H-bridge.

21. The method of claim 12 wherein the rise time and fall time of the AC voltage across the EL lamp each constitute between 5% and 25% of the waveform,
